(19) United States
(12) Patent Application Publication
(10) Pub. No.: US 2016/0087900 A1
(43) Pub. Date: Mar. 24, 2016

(54) A COMMUNICATION NODE FOR A PACKET-SWITCHED DATA NETWORK AND A METHOD FOR OPERATION THEREOF

(71) Applicant: CETITEC GMBH, Pforzheim (DE)

(72) Inventor: Bojan KOLMANIC, Pforzheim (DE)

(21) Appl. No.: 14/891,637

(22) PCT Filed: Dec. 10, 2014
(86) PCT No.: PCT/EP2014/077166

§ 371 Date: Nov. 16, 2015

(30) Foreign Application Priority Data
Dec. 20, 2013 (DE) 10 2013 226 977.3

(51) Int. Cl. H04L 12/819; H04L 7/00; H04L 29/08; H04L 1/00; H04L 12/40; H04B 17/30

(52) U.S. Cl. CPC H04L 47/21; H04L 12/40117; H04B 17/30; H04L 67/1051; H04L 1/0042; H04L 7/0012

(57) ABSTRACT

A communication node for a packet-switched data network is proposed, which comprises an integrated circuit having a system of electronic components for sending and/or receiving audio and/or video data, particularly of an audio and/or video data stream. A media access control component for implementing a media access control and a physical interface with transmitting and receiving means, by way of which the communication node is connectable to a communication line of the data network, are provided as components of the system. The media access control component is connected via an internal first interface to the physical interface for exchanging data. The system comprises a real-time clock synchronization unit for synchronizing time information with other communication nodes of the data network as well as a queue management unit. The real time clock synchronization unit and the queue management unit are fully arranged in the physical interface.

The invention relates to a communication node for a packet-switched data network, which comprises an integrated circuit with a system of electronic components for sending and/or receiving audio and/or video data, particularly of an audio and/or video data stream. The invention further relates to a method for operating such a communication node.

An integrated circuit with a system of electronic components is known as a system on a chip (SoC). In such a system, all or a large part of the functions of the system are disposed on a single chip, i.e. an integrated circuit. A system refers here to a combination of various elements, such as logic circuits, clocking and the like, which together provide a specific functionality. Such integrated circuits are used for example in embedded systems. A possible field of application of SoCs is for example sending and/or receiving audio and/or video data (so-called streaming).

A number of IEEE 802.1 standards for synchronized and prioritized streaming of audio and video data across networks are combined under the term “audio video bridge” (AVB). AVB includes amongst others the standards IEEE 802.1AS (Timing and Synchronisation for Time-Sensitive Applications (gPTP)) and IEEE 802.1Qav (Forwarding and queuing for time-sensitive streams). The standard IEEE 1722 (Transport Protocol for Time-Sensitive Applications (Audio Video Transport Protocol, AVTP) is also used in the AVB context. AVB allows using a packet-switched data network, such as for example Ethernet based networks, for duplex transmission of numerous audio and video channels. In the process, time synchronization between communication nodes connected to the data network is carried out by way of time information. By using existing standard Layer-2 MACs (Media Access Controller) and bridges, AVB allows for backward compatibility between communication nodes using AVB and communication nodes that do not use AVB, whereby these nodes can communicate via customary frameworks designed according to the IEEE 802 standard.

Allowing a communication node to use AVB requires making various modifications to the hardware and software of the communication node. For example, the IEEE 802.1AS standard asks for a more precise timestamp of incoming and outgoing data packets. Timestamping is typically carried out within a media access control component (e.g. an Ethernet MAC) of the integrated circuit (SoC) modified to that end. This ensures that the sending time of the data packet is as close as possible to the timestamping time. For this reason, this functionality is carried out, as a rule, in hardware (hardware assisted time stamping). In contrast, generating synchronization messages as well as messages regarding propagation delays are provided as software in the media access control component.

As a rule, a queue management unit described in IEE 802.1Qav is implemented on a FIFO (first in-first out) basis. Hereby, data packets are output according to specific criteria to a communications line of a data network, to which the communication node is connected. However, this requires a certain amount of processing power, in order to be able to fulfill the real-time requirements of AVB.

The problem underlying the present invention is to provide a communication node for a packet-switched data network, which is adapted for unrestricted use of AVB and at the same time reduces the processing load of the media access control component while fulfilling all real-time requirements. In doing so, the communication node must be backward compatible and be able to communicate with other communication nodes that do not support AVB. Another problem underlying the invention is to provide a method for operating such a communication node.

This problem is solved by a communication node according to the features of claim 1 and by a method according to the features of claim 13. Advantageous embodiments are set out in the dependent claims.

In order to solve this problem, a communication node for a packet-switched data network is proposed, which comprises an integrated circuit having a system of electronic components for sending and/or receiving audio and/or video data. The packet-switched data network is particularly Ethernet or based on Ethernet.

The integrated circuit particularly comprises a system of electronic components for sending and/or receiving an audio and/or video data stream. Such an integrated circuit with a system of electronic components is provided for example in the form of a SoC. The provided components of the system are at least a media access control component for implementing a media access control and a physical interface with transmitting and receiving means, by way of which the communication node is connectable to a communication line of the data network. The media access control component is for example an Ethernet MAC. The physical interface is for example designed in the form of an Ethernet PHY. This refers to a special integrated circuit or a functional group of an integrated circuit that is responsible for encoding and decoding data between a purely digital system and a modulated analog system.

The media access control component is connected via an internal first interface to the physical interface for exchanging data. The system additionally comprises a real-time clock synchronization unit for synchronizing time information with other communication nodes of the data network as well as a queue management unit. According to the invention, the real time clock synchronization unit and the queue management unit are fully arranged in the physical interface.

In the proposed communication node, the integrated circuit is relieved of all real-time requirements caused by AVB. Instead, the AVB functionality is arranged in the physical interface. This allows for backward compatibility and for a more cost-efficient implementation of an AVB communication node, since the design of an AVB-compliant integrated circuit is considerably more complex than equipping the physical interface, which is, as a rule, disposed separately in the communication node, with the necessary components and functionalities. By exchanging a conventional physical interface with the interface according to the invention, a communication node can be made AVB compatible.

Since the physical interface processes all the tasks related to AVB in real time, the interrupt load on the integrated circuit caused by AVB is considerably reduced. Another advantage is that the internal first interface provided between the physical interface and the media access control component is exclusively available for transmission of data packets (with payload). This means that the bandwidth that is made available by the internal first interface is increased compared to conventional communication nodes, in which AVB tasks are carried out by the media access control component.

According to an advantageous embodiment, the media access control component does not have any real time clock synchronization and queue management functionality. That way, interrupt requests sent to the integrated circuit because of AVB can be avoided. In addition, the communication node's backward compatibility is improved.

According to another advantageous embodiment, the real time clock synchronization unit in the physical interface is based on the standard IEEE 802.1AS and implements all of its functionalities.

According to another advantageous embodiment, a first part of the functionality of the real time clock synchronization unit is carried out, as hardware, in the physical interface, which is able to, particularly autonomously, implement time synchronization with other communication nodes of the data network. The functionality of the real-time clock synchronization unit, implemented as hardware, pertains particularly to providing incoming and outgoing data packets with time stamps in accordance with AVB requirements. Autonomous time synchronization means that no communication is carried out between the physical interface and the media access control components for implementing the provided hardware functionality.

In another advantageous embodiment, a second part of the functionality of the real time clock synchronization unit is carried out, as software, in the physical interface, with the aim of implementing a measurement of propagation delays and/or the transmission of information for time synchronization and/or choosing one of the communication nodes of the data network as a master node. This information is used for time synchronization by the communication nodes connected to the data network.

According to another advantageous embodiment, the real-time clock synchronization unit in the physical interface comprises at least one register, in which a single or several pieces of time information determined by the real-time clock synchronization unit are stored during operation of the communication node, wherein the at least one register is readable via the first interface by the media access control component and/or by another component of the system. For example, one register stores the local time of the communication node, which is synchronized with a master time (the so-called grandmaster clock).

The first interface, through which data is exchanged within the communication node between the media access control component and the physical interface, is advantageously the Media Independent Interface (MII).

According to another advantageous embodiment, the real-time clock synchronization unit is configurable as master node or as slave node, by storing a predetermined piece of information in a predetermined register during operation of the communication node, the information being readable by the media access control component and/or by another component of the system via the first interface. This allows for time synchronization between the nodes of the packet-switched data network without requiring communication with the media access control component or another component of the system.

According to another embodiment, the physical interface can comprise a device for encoding and/or decoding audio data, particularly according to the IEEE 1722 Transport specification. This device (codec) makes it possible to stream and decode audio data from another communication node, so that the corresponding data can be processed either by a component of the integrated circuit or by another external audio component, without further processing. For example, such a component can be a sound card within the integrated circuit of the communication node or another external audio terminal (for example an MP3 player).

According to another embodiment, the device for encoding and/or decoding audio data can be coupled via a second interface with the system or with an external audio component for directly exchanging data. Particularly, the second interface can be a serial audio interface, such as for example I²S.

According to another embodiment, the queue management unit can be configured to execute the leaky bucket algorithm. Particularly, when the optional second interface is provided, the data received via the second interface from the first interface is processed by the queue management unit according to the used algorithm. By providing the second interface for transmitting audio data, the bandwidth can be further increased via the first interface. Since, according to the invention, managing the queue is no longer carried out in the integrated circuit (SoC) but in the physical interface, the processing load of the integrated circuit, particularly of the media access control component is considerably reduced. The saved processing power can thus be allocated to other tasks by the integrated circuit.

In order to solve the problem, a method for operating a communication node for a packet-switched data network is furthermore proposed, wherein the communication node is adapted according to the above description. In the method according to the invention, only the real time clock synchronization unit arranged in the physical interface carries out a particularly autonomous time synchronization process with other communication nodes of the data network as well as a measurement of propagation delays and/or the transmission of information for time synchronization and/or choosing one of the communication nodes of the data network as a master node.

The method according to the invention has the same advantages as those described above with respect to the communication node of the invention.

The term “only” means that the media access control component or the integrated circuit, respectively a component of the integrated circuit, are not involved in the implementation of the mentioned functions and tasks. Particularly, the mentioned tasks are carried without any communication between the physical interface and the integrated circuit.

According to another embodiment of the proposed method, the queue management unit outputs data packets, which are received from the first and second interface of the system, or optionally of the external audio component, according to specific criteria to the communication line of the data network for transmission.

According to another embodiment of the method according to the invention, the real-time clock synchronization unit stores one or several pieces of time information in a register or a respective register, in order to provide the one or several pieces of information, for processing, to the media access control component and/or to the one other component of the system, by a read access to the register(s), via the first interface.

In another embodiment of the method according to the invention, the real-time synchronization unit writes a predetermined piece of information into a predetermined register, wherein the predetermined piece of information indicates whether the communication node is configured as a master node or as a slave node, wherein the predetermined register is readable, by a read access, by the media access control component and/or another component of the system, via the first interface.

In the following, the invention is described in more detail based on exemplary embodiments with reference to the drawings. In the drawings:

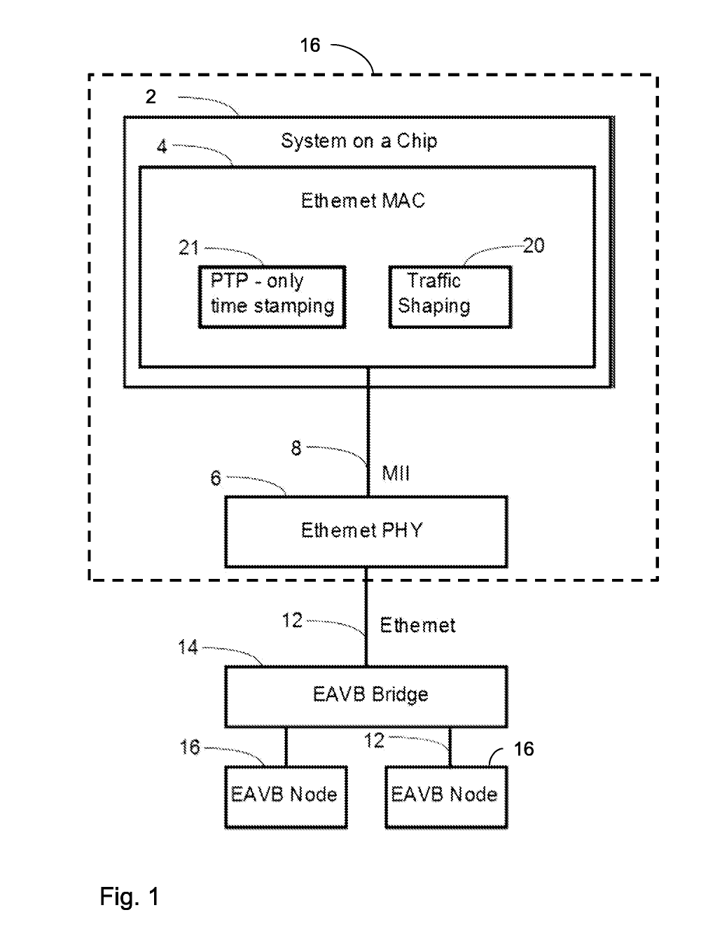

FIG. 1 shows a schematic representation of a packet-switched data network with several communication nodes, wherein one of the communication nodes is designed in the conventional manner for implementing AVB.

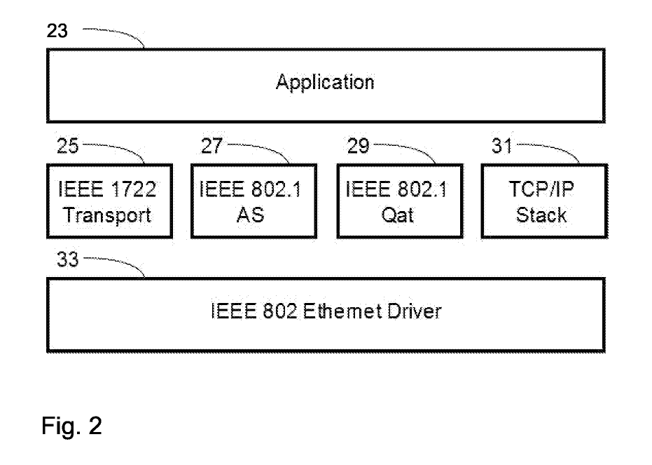

FIG. 2 shows a schematic representation of an AVB software stack;

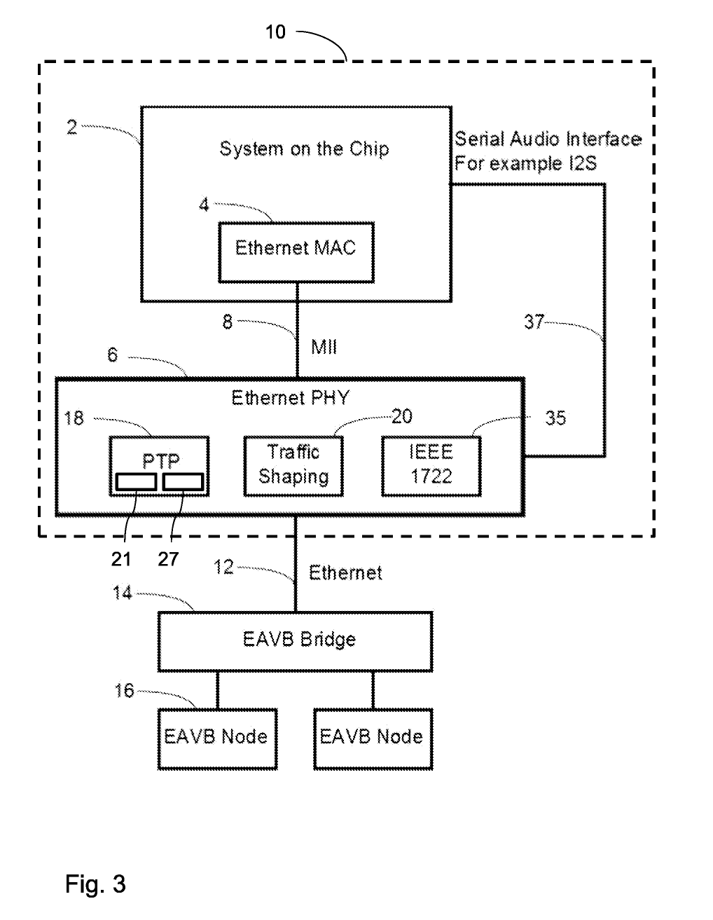

FIG. 3 shows a schematic representation of a packet-switched data network with a communication node designed according to a first embodiment of the invention; and

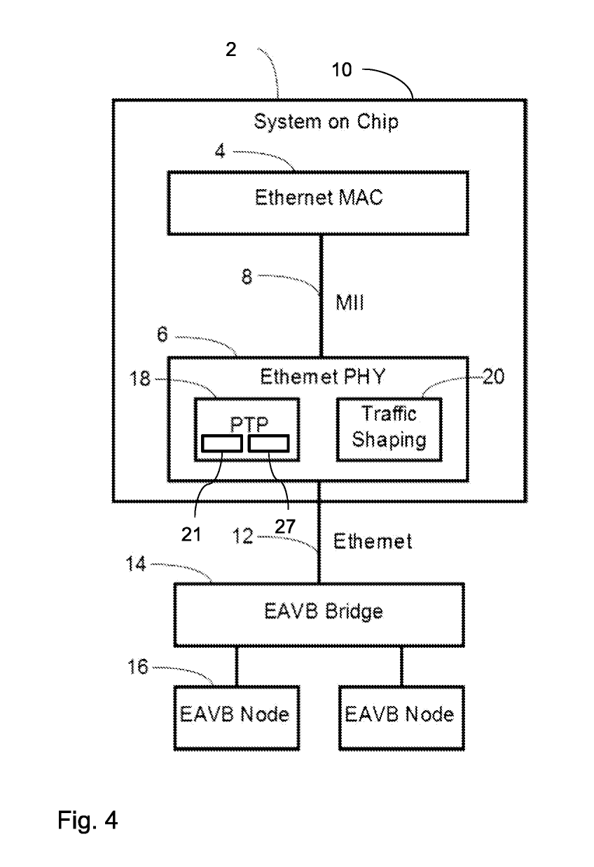

FIG. 4 shows a schematic representation of a packet-switched data network with a communication node designed according to a second embodiment of the invention.

FIG. 1 shows a schematic representation of a packet-switched data network with several communication nodes 16. In the exemplary embodiment, the data network is Ethernet-based. The communication nodes 16, also known as Ethernet AVB or EAVB nodes, are connected to an Ethernet AVB bridge (“EAVB bridge”) via lines 12. In this example, three communication nodes 16 are shown. In practice, this number can vary and can particularly be greater. The lines 12 represent wired or wire-less communication channels. In this example, the communication nodes 16 of the packet-switched data network are designed to implement AVB. To simplify matters, the components that are required to this end are only represented for one of the communication nodes 16. Communication nodes 16 that are not designed to implement AVB can also be connected to the EAVB bridge 14.

The communication node 16 comprises an integrated circuit 2 in the form of an SoC (system on a chip) and a physical interface 6 in the form of an Ethernet PHY. The integrated circuit 2 and the physical interface 6 are connected for exchanging data within the communication node 16 by way of an internal first interface 8 in the form of an MII (media independent interface).

The integrated circuit 2 comprises electronic components on a common chip, such as for example digital components, analog components, mixed-signal components and functions for sending and receiving data (RF (radio frequency) functions). In the field of mobile terminals or consumer electronics, the integrated circuit 2 is typically an embedded system.

It should be noted that in the present description, a SoC is merely an example for an integrated circuit. In the field of desktop computers, a CPU is similarly connected to an Ethernet over PCI.

The integrated circuit 2 of the communication node 16 comprises a media access control component 4 (Ethernet MAC). In the media access control component 4, there is provided a device 21 implemented as hardware for implementing AVB, which serves to provide data packets received from the communication node 16 or to be sent by the communication node 16 to one of the other schematically shown communication nodes 16 with a respective timestamp. This functionality is referred to as PTP-only timestamping. The other functionalities of IEEE 802.1AS (gPTP) are implemented in software, which is also executed on the media access control component 4. They are for example functionalities for implementing a measurement of propagation delays and/or a transmission of information for time synchronization and/or choosing one of the communication nodes of the data network as a master node.

In addition, there is provided, in the media access control component 4, a queue management unit 20 (traffic shaping), which delays or rejects data packets to be sent from the communication node 16 to one of the other communication nodes 16 based on specific criteria, in order to meet given requirement profiles. A frequently used algorithm is the leaky bucket algorithm.

The media access control component 4 is generally a component that carries out the MAC (medium access controller) sub-layer of layer 2. The media access component 4 is typically designed as a part of the integrated circuit 2 and connected, by way of an internal system bus (not shown), with other components of the integrated circuit for exchanging data. In the case of a CPU, the media access control component 4 is frequently formed on an expansion card (e.g. a PCI card).

The media access control component 4 is connected to the physical interface 6 via the first internal interface 8 (MII). The physical interface 6 is also often referred to as a PHYceiver, which is a component that operates on the physical layer. For instance, the interface implements 1000Base-T, 100Base-T, etc.

The first internal interface 8 is a standardized interface, which is connected to the physical interface 6 for connection with the media access control component 4. In practice, various variants are used, such as for example RGMII (Reduced Gigabit Media Independent Interface) and SGMII (Serial Gigabit Media Independent Interface).

When the present description refers to Ethernet, it is the physical layer that is referred to. The transmission can be carried out via a coaxial cable, a twisted pair cable or an optical fiber cable. The speeds can vary between 10 Mb/s and 100 Gb/s. The Ethernet protocol stack operates in a similar fashion as other physical layers and is defined in the OSI layer model (ISO/IEC 7498-1).

The EAVB Bridge 14 connects a plurality of communication nodes 16. The EAVB bridge 14 operates in a similar fashion as known Ethernet switches. In addition, the EAVB bridge 14 supports additional AVB features, such as for example PTP, queue processing (traffic shaping) and stream reservation.

Each of the communication nodes 16 can act as an AVB talker or AVB listener within the data network. As described, the integrated circuit 2 and the physical interface 6 are designed as an embedded system.

An AVB communication node 16 as described in FIG. 1 additionally comprises an AVB software stack, which is schematically shown in FIG. 2. The reference number 23 refers to an application. In the context of AVB, the application 23 is a streaming application, either as talker or as listener. The reference number 33 indicates an Ethernet driver according to the IEEE 802 standard. The driver 33 constitutes a driver of the media access control component 4. It typically writes Ethernet data packets from the TCP/IP stack 31 into a memory of the media access control component 4 and vice versa. In the case of an AVB protocol, the driver 33 is directly addressed, since all AVB protocols are executed on layer 2.

The reference number 25 (“IEE 1722 Transport”) refers to a component, which is disposed in the integrated circuit 2, typically outside of the media access control group 4, and which is responsible for integrating the transport layer implemented according to IEEE 1722 into the provided system architecture. For example, the component can be an ALSA sound driver that supports playback and recording on the Linux operating system.

The reference number 27 (“IEEE 802.1AS”) refers to a software component that is responsible for implementing a measurement of propagation delays, for transmitting information for time synchronization and for choosing a communication node of the data network as a master node. This software component is typically disposed in the integrated circuit 2 and outside of the media access control component 4.

The reference number 29 (“IEEE 802.1Qat”) refers to a stream registration protocol that utilizes three different signaling protocols, MMRP, MVRP and MSRP to establish stream reservations in the data network having an EAVB bridge. The software component 29, which does not have any real-time requirements, is typically disposed in the integrated circuit 2 and outside of the media access control component 4. MSRP (Multiple Stream Registration Protocol) is a signaling protocol that allows end nodes to reserve resources of the data network, thus providing quality of service (QoS) when transmitting and receiving data streams across the entire data network.

The reference number 31 (“TCP/IO”) refers to a set of TCP/IP protocols, which can be for example IP, ARP, ICMP, UDP, TCP, IGMP protocols. The TCP/IP stack is usually reserved for the operating system. Like the driver 33, it is disposed, from the standpoint of the OSI layer model, above the media access control component 4 in the integrated circuit 2.

By using the variants described in the following exemplary embodiments according to FIGS. 3 and 4, the integrated circuit 2 (SoC) can be freed of all real-time requirements introduced by AVB. As opposed to the other communication nodes 16, the reference number 10 refers to a communication node designed according to the invention (EAVB node). To this end, according to the invention, the real-time clock synchronization unit 21 together with the associated software-controlled functionality (reference number 27 in FIG. 2) and the queue management unit 20 are completely disposed in the physical interface 6. This makes it possible to integrate AVB in the communication node without having to modify the integrated circuit 2. Thereby, backward compatibility with non-AVB-conform communication nodes can be implemented. One advantage thereof is that there are less interrupt requests sent by AVB to the integrated circuit 2. During the execution of AVB applications, the integrated circuit 2 is also considerably less burdened since PTP time synchronization and queue management is handled by the physical interface 6. The same also applies to the handling of data packets in accordance with the IEEE 1722 standard, provided the corresponding functionality is also optionally provided in the physical interface 6.

It goes without saying that the corresponding AVB software functionalities can be removed from the software stack of the integrated circuit 2 shown in FIG. 2. This applies particularly to the software components labeled with the reference numbers 25, 27 and 29 in FIG. 2. It is also clear that the hardware components labeled with the reference numbers 20 and 21 in FIG. 1 are also no longer included in the integrated circuit 2. In accordance with the invention, the integrated circuit 2 shown in FIG. 2 does not support any AVB feature, i.e. neither queue management nor timestamping of data packets. As described, these functionalities are directly implemented in the physical interface 6.

The real-time clock synchronization unit 18 designed according to the invention and located inside the physical interface 6 is responsible for time synchronization with the other communication nodes 16. The other communication nodes 16 may be designed according to the invention or in the conventional manner. Synchronization takes place in accordance with the IEEE 802.1AS standard in the following manner: one of the communication nodes 10, 16, serving as a grandmaster node, sends information that comprises a synchronized time to all other communication nodes 10, 16 of the data network. Each of these (AVB) communication nodes must correct the time received from the grandmaster node by taking into account a propagation time taken by the data packet received from the grandmaster node to arrive at the communication node. Determining this propagation time requires a forwarding delay and a transmission time. The forwarding delay is the time required by the EAVB bridge 14 for processing the data packet in question. The EAVB bridges 14 can determine this time (also called residence time) themselves.

The real-time clock synchronization unit 18 is responsible for determining the propagation delay. A corresponding result is stored in a register (not shown) of the physical interface 6. The integrated circuit 10 or one of its components can read this time for further processing through a read access to the register of the physical interface 6 via the first interface 8. For example MDIO, i.e. a specific interface referred to as PHY Management Interface, can be used as part of the MII to this end. Integrating the timestamp in a PTP message is carried out directly by the real-time clock synchronization unit 18. The real-time clock synchronization unit 18 additionally has a register for a local time, which is synchronized with the grandmaster clock.

With a predetermined piece of information stored in another register of the physical interface 6, the real-time clock synchronization unit 18 can be configured as a master or as a slave.

All PTP messages are transmitted to the media access control component 4. This is necessary for example to execute algorithms that are not real-time sensitive.

If, as shown in the exemplary embodiments according to FIGS. 3 and 4, the device 35 for encoding and/or decoding audio and/or video data according to IEEE 1722 is provided, the communication node 10 has a second internal interface 37 available for transmitting serial audio data. For example, the interface can be I²S. An advantage of this approach is that, in this case, encoding and decoding audio data can be carried out directly in the physical interface 6 and the integrated circuit 2 is relieved of the corresponding processing load. In addition, since transmission of the audio data is carried out via the second interface 37, which, in the case of the integrated circuit 2, is connected to a sound card contained therein, the first interface 8 provides a high bandwidth for transmitting a payload.

The first interface 8 (MII) provided in a communication node 10 according to the invention includes all current and possible variants as well as future developments, such as for example Reduced Media Independent Interface, Gigabit Media Independent Interface, Reduced Gigabit Media Independent Interface, Serial Gigabit Media Independent Interface, 10 Gigabit Media Independent Interface, XAUI, GBIC, SFP, SFF, XFP and XFI.

The exemplary embodiment shown in FIG. 4 differs from the exemplary embodiment shown in FIG. 3 in that the physical interface 6 is also integrated in the integrated circuit 2. There are no functional differences.

Queue management of data packets according to IEEE 1722, i.e. of audio and/or video data to be transmitted by the device 35 for encoding and/or decoding, as well as data packets received by the media access control component 4 via the first interface 8, is carried out by the queue management unit 20, in order to fulfill specific requirements profiles for the data stream. The queue management unit 20 also has one or several registers for configuring the queue flow. The queue management unit 20 is preferably implemented in hardware.

### LIST OF REFERENCE NUMBERS

2 integrated circuit (system on a chip (SoC))

4 media access control component (Ethernet MAC)

6 physical interface (Ethernet PHY)

8 first interface (MII—Media Independent Interface)

10 communication node (EAVB node)

12 Ethernet line

14 EAVB-bridge (Ethernet AVB bridge)

16 other communication nodes (EAVB node)

18 real-time clock synchronization unit

20 queue management unit (traffic shaping)

21 real-time synchronization unit with limited functionality

23 Application

25 IEEE 1722

27 IEEE 802.1AS

29 IEEE 802.1Qat

31 TCP/IP

33 IEEE 802 Ethernet driver

35 device for encoding and/or decoding audio and/or video data (codec)

1. A communication node for a packet-switched data network, which comprises an integrated circuit with a system of electronic components for sending and/or receiving audio and/or video data, particularly of an audio and/or video data stream, wherein at least a media access control component for implementing a media access control and a physical interface with transmitting and receiving means, by way of which the communication node is connectable to a communication line of the data network, are provided as components of the system, wherein the media access control component is connected via an internal first interface to the physical interface for exchanging data, and wherein the system comprises a real-time clock synchronization unit for synchronizing time information with other communication nodes of the data network as well as a queue management unit,
characterized in that
the real time clock synchronization unit and the queue management unit are fully arranged in the physical interface.

2. The communication node according to claim 1, characterized in that the media access control component does not have any functionality of the real time clock synchronization unit and of the queue management unit.

3. The communication node according to claim 1, characterized in that the real time clock synchronization unit is based on the standard 802.1AS and has implemented all of its functionalities.

4. Communication node according to claim 3, characterized in that a first part of the functionality of the real time clock synchronization unit is carried out as hardware, by which time synchronization with other communication nodes of the data network is, particularly autonomously, operable.

5. The communication node according to claim 3, characterized in that a second part of the functionality of the real time clock synchronization unit is carried out as software for implementing a measurement of propagation delays and/or the transmission of information for time synchronization and/or choosing one of the communication nodes of the data network as a master node.

6. The communication node according to claim 1, characterized in that the real-time clock synchronization unit comprises at least one register, in which a single or several pieces of time information determined by the real-time clock synchronization unit are stored during operation of the communication node, wherein the at least one register is readable via the first interface by the media access control component and/or by another component of the system.

7. The communication node according to claim 1, characterized in that, the first interface is the Media Independent Interface (MII).

8. The communication node according to claim 1, characterized in that the real-time clock synchronization unit is configurable as master node or as slave node by storing a predetermined piece of information in a predetermined register during operation of the communication node, the information being readable by the media access control component and/or by another component of the system via the first interface.

9. The communication node according to claim 1, characterized in that the physical interface comprises a device for encoding and/or decoding audio data, particularly according to the specification IEEE 1722 Transport.

10. The communication node according to claim 9, characterized in that the device for encoding and/or decoding audio data is coupled via a second interface with the system or with an external audio component for directly exchanging data.

11. The communication node according to claim 10, characterized in that the second interface is a serial audio interface, particularly I²S.

12. The communication node according to claim 1, characterized in that the queue management unit is configured to execute the leaky bucket algorithm.

13. A method for operating a communication node for a packet-switched data network, wherein the communication node is adapted according to claim 1, in which
only the real time clock synchronization unit arranged in the physical interface carries out a particularly autonomous time synchronization process with other communication nodes of the data network as well as a measurement of propagation delays and/or transmission of information for time synchronization and/or choosing one of the communication nodes of the data network as a master node.

14. The method according to claim 13, wherein the queue management unit outputs data packets, which are received from the first and second interface by the system, or optionally by the external audio component, according to specific criteria, to the communication line of the data network for transmission.

15. The method according to claim 13, wherein the real-time clock synchronization unit stores one or several pieces of time information in a register or a respective register, in order to provide the one or several pieces of information, for processing, to the media access control component and/or to the one other component of the system, by a read access to the register(s), via the first interface.

16. The method according to claim 13, wherein the real-time synchronization unit writes a predetermined piece of information into a predetermined register, wherein the predetermined piece of information indicates whether the communication node is configured as a master node or as a slave node, wherein the predetermined register is readable, by a read access, by the media access control component and/or another component of the system, via the first interface.
